(19) United States
(12) Patent Application Publication
(10) Pub. No.: US 2008/0130213 A1
(43) Pub. Date: Jun. 5, 2008

(54) Electronic apparatus and component

(75) Inventors: Katsuichi Goto, Kawasaki (JP); Yuichi Fujisawa, Kawasaki (JP); Hiroshige Nakayabu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/902,324

(22) Filed: Sep. 20, 2007

(30) Foreign Application Priority Data
Dec. 5, 2006 (JP) 2006-328693

(51) Int. Cl. G06F 1/16

(52) U.S. Cl. 361/683; 16/261; 439/165

(57) ABSTRACT

The component has a first opening through which a cable is inserted, and a second opening through which a fastening component is inserted. The second opening is connected to the first opening such that the second opening accepts a portion of the cable when the cable is inserted through the first opening.

### BACKGROUND OF THE INVENTION

1. Field of the Invention

The present invention relates to an electronic apparatus such as a personal computer, and a component used in the electronic apparatus.

2. Description of the Related Art

In recent years, an electronic apparatus such as a personal computer (hereinafter, abbreviated as a “PC”) has been rapidly miniaturized, lighter in weight and sophisticated in function. However, actually, a number of cables connecting electronic components are arranged inside the electronic apparatus. For example, in a notebook type personal computer (hereinafter, abbreviated as a “notebook PC”) having a structure in which a main unit and a display unit are connected by a hinge connection to open and close with respect to each other, the main unit provided with a keyboard on its upper face and a calculation circuit inside, and the display unit including a display screen, it is common that a cable extends between the main and display units.

A wiring route for such cable extending in the electronic apparatus is regulated in the electronic apparatus.

For example, Japanese Registered Utility Model Publication No. 3001056 shows a method in which a wiring route for a cable is regulated by arranging a cable guiding groove in a printed circuit board and fitting a part of the cable into the cable guiding groove.

Japanese Patent Application Publication No. S53-139199 shows a method in which a wiring route for a cable is regulated by inserting the cable through a through opening in a center of a supporting plate.

In addition, in a notebook PC, as a method of regulating a wiring route for a cable extending between its main and display units, there may be applied a method in which a through opening is arranged in a decorative component which covers a hinge connecting the main and display units to prevent the hinge from appearing in an external appearance of the notebook PC, and a wiring route for the cable is regulated by inserting the cable through the through opening.

However, as a number of cables extending between the main and display units are provided, it is inconvenient for assembling each cable one by one. Accordingly, a cable in which those cables are connected together with a connector is commonly used. When the cable is inserted through an opening arranged in a decorative component, operability is poor if the opening is small. It is not preferable to arrange a large opening, since it makes the decorative component poor in design and large in size, which may lead to a large and heavy electronic apparatus as a whole.

Such problems are not particular only in the case in which a wiring route for a cable extending in a hinge portion of a notebook PC, but is a common problem for portion in which a wiring route for a cable is regulated by inserting the cable through an opening arranged in a component.

Japanese Patent Application Publication No. S53-139199 discloses a technique in which when a cable is inserted through a through opening, a slit is arranged in order to remove poor operability in which the cable is inserted from an end of the cable, a mid portion of the cable is inserted through the through opening via the slit. In such case, since the cable may come out from the through opening through the slit, the technique is unsuitable, especially for wiring in a movable section.

### SUMMARY OF THE INVENTION

In the view of foregoing, according to the present invention, there are provided a component and an electronic apparatus in which the component is arranged, which improve operability of inserting a cable through a cable inserting opening arranged in the component, considering a diameter of the through opening.

An electronic apparatus according to the invention includes:

a component including a first opening through which a cable is inserted,

wherein the cable includes a connector section having a width larger than a diameter of the first opening and a cable section having a width which enables the cable to be inserted through the first opening, and

the cable further includes a second opening which is connected to the first opening such that the connector section of the cable can be accepted when the cable is inserted through the first opening.

In addition, an electronic apparatus according to the invention includes a component in which a first opening and a second opening are arranged, the first opening through which a cable is inserted, the second opening through which a fastening component is inserted, wherein the second opening is connected to the first opening such that the second opening accepts a portion of the cable when the cable is inserted through the first opening.

In the electronic apparatus according to the invention, the first and second through openings are connected. When a cable is inserted through the first through opening, the second through opening accepts a portion of the cable to make an insertion of the cable easy. After the cable is inserted through the through opening, the fastening component is inserted through the second through opening.

Here, the electronic apparatus according to the invention may include:

a first unit and a second unit both of which open and close with respect to each other; and

a hinge member that connects the first and second units such that the first and second units freely open and close with respect to each other and that supports the first and second units in any state in which the first and second units open and close,

wherein the component is a component through which a cable extending between the first and second units is inserted and which is fixed to the hinge member.

The invention can be desirably applied to a movable section such as a connection section for the first and second units.

In a case in which the invention is applied to a hinge connection section, the component may be a component which is fixed to the hinge member by a screw which is inserted through the second opening. In addition, the component may be a component which regulates a route of wiring a cable by inserting the cable through the first opening, and which is fixed to the hinge member to cover an external appearance of the hinge member.

In addition, a component according to the invention is a component that is used for an electronic apparatus and that includes a first opening through which a cable is inserted, wherein:

the cable includes a connector section having a width larger than a diameter of the first opening and a cable section having a width which enables the cable to be inserted through the first opening, and

the component includes a second opening which is connected to the first opening such that the connector section of the cable can be accepted when the cable is inserted through the first opening.

In addition, a component according to the invention is a component used for an electronic apparatus wherein:

a first opening through which a cable is inserted and a second opening through which a fastening component is inserted are formed thereon, and

the second opening is connected to the first opening such that the second opening accepts a portion of the cable when the cable is inserted through the first opening.

Here, the component according to the invention may be a component,

wherein the electronic apparatus includes a first unit and a second unit both of which open and close with respect to each other, and a hinge member that connects the first and second units such that the first and second units freely open and close to each other and that supports the first and second units in any state in which the first and second units open and close, and

the component is a component through which a cable extending between the first and second units is inserted and which is fixed to the hinge member. In this case, the component may be a component wherein the component is fixed to the hinge member by a screw which is inserted through the second opening. In addition, the component may be a component wherein the component regulates a route of wiring a cable by inserting the cable through the first opening, and which is fixed to the hinge member to cover an external appearance of the hinge member.

According to the invention described above, considering the size of a through opening which is arranged in a component and through which a cable is inserted, an operability for inserting a cable through the through opening can be improved.

### BRIEF DESCRIPTION OF THE DRAWINGS

FIG. 1 is a perspective view of a notebook PC in a closed state.

FIG. 2 is a perspective view of the notebook PC in an opened state.

FIG. 3 is an enlarged view showing a portion of one of decorative components of the notebook PC shown in FIGS. 1 and 2.

FIG. 4 is an exploded view showing, from above, the notebook PC shown in FIGS. 1 and 2 in a state in which a keyboard and a decorative plate are removed therefrom.

FIG. 5 is an exploded view showing the notebook PC in a state in which a top cover covering a top of a main unit and components fixed on the top cover are further removed from the main unit in a state in which a key board and the like are removed as shown in FIG. 4.

FIG. 6 is an enlarged view showing a portion around the decorative component in the state shown in FIG. 5.

FIG. 7 is an enlarged view showing a portion around the decorative component in a state in which the main unit is removed from the PC in the state shown in FIGS. 5 and 6.

FIG. 8 is a perspective view showing the decorative component itself from the front side.

FIG. 9 is a perspective view showing the decorative component from the backside.

FIG. 10 is a perspective exploded view showing a position relation between a hinge member and the decorative component.

FIG. 11 is a diagram showing a state in which a cable is inserted through the decorative component.

FIG. 12 is another diagram showing a state in which the cable is inserted through the decorative component.

FIG. 13 is a perspective view showing the decorative component in a state in which the cable is inserted through the decorative component arranged on the hinge member.

FIG. 14 is a perspective view showing an inner face of the top cover covering the main unit removed as shown in FIG. 5.

FIG. 15 is a perspective exploded view showing the inner face of the top cover and a board fixing member is removed, and the board fixing member in the state in which the board fixing member is removed from the top cover.

FIG. 16 is an enlarged perspective view showing the board fixing member in a state in which a flexible board is fixed to the board fixing member.

FIG. 17 is an exploded perspective view showing both the flexible board and the board fixing member.

FIG. 18 is a perspective view showing a back face of the flexible board.

FIG. 19 is an enlarged view showing a front face of a portion covering the top of the main unit to which portion the board fixing member is fixed.

### DETAILED DESCRIPTION OF THE INVENTION

In the following, an exemplary embodiment will be described. Here, a notebook PC as one example of the electronic device according to the present invention will be described.

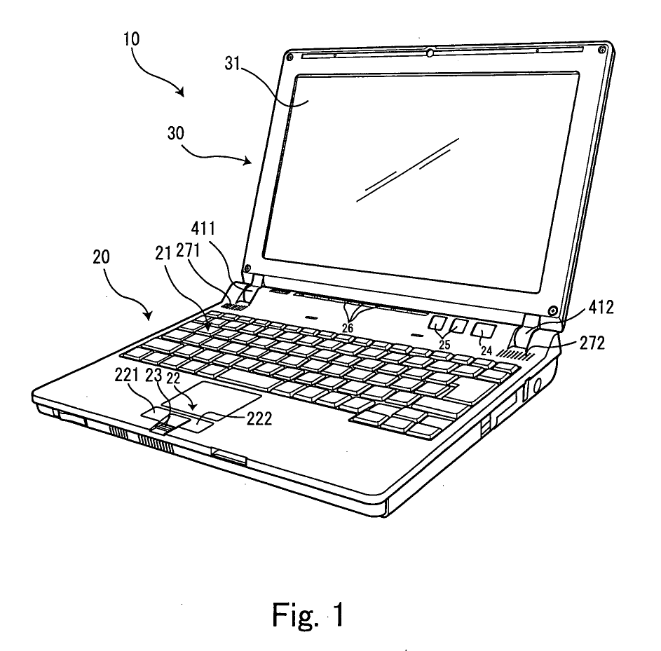

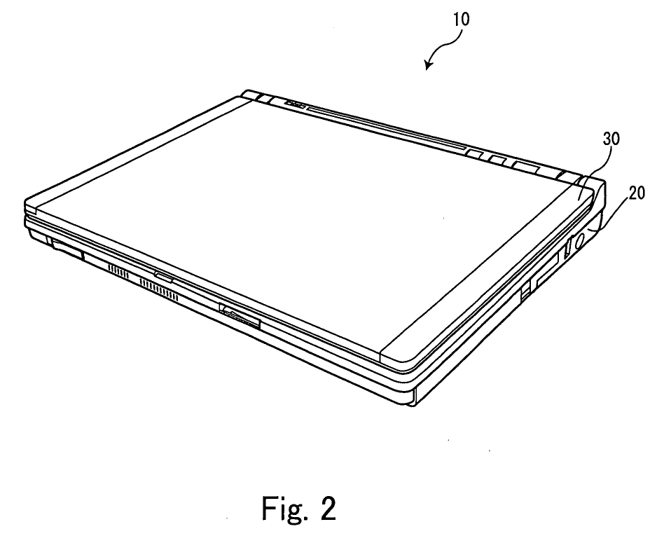

FIG. 1 is a perspective view of a notebook PC in an opened state. FIG. 2 is a perspective view of the notebook PC in an opened state.

This notebook PC 10 includes a main unit 20 and a display unit 30. The display unit 30 is connected through a hinge to the rear of the main unit 20 to open and close freely.

The main unit 20 includes inside its casing various components such as circuit components exemplified by a CPU, a hard disk drive unit including a hard disk, a disk drive unit in which a CD or a DVD is freely loaded to be accessed and unloaded, a PC card slot into which a PC card is inserted to be accessed, and a memory card slot into which various kinds of memory cards are inserted to be accessed.

In addition, on a top face of the main unit 20, are arranged a keyboard 21, a touch pad 22, right and left push buttons 221, 222 for the touch pad, a finger print sensor 23 located in the center between the right and left buttons 221, 222, a main power button 24, multiple function buttons 25, multiple display marks 26, a sound emitting openings 271, 272 for emitting sounds from an inside speaker and etc.

Here, the display marks 26 are arranged on an upward-facing part of the top of the main unit 20. The main power button 24 and function buttons 25 are arranged on a part facing obliquely forward, considering operability.

In addition, a display screen 31 spreaded in a center of the display unit 30 is provided in the display unit 30.

The display unit 30 is hinged to the main unit 20 with a hinge member described later. Decorative components 411 and 412 are fixed to the hinge member such that the hinge member is not exposed at an external appearance of the notebook PC 10.

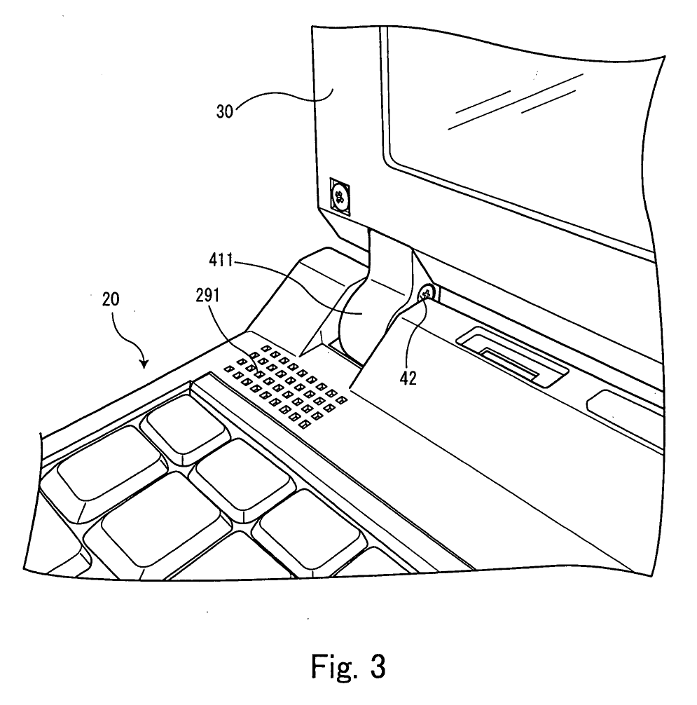

FIG. 3 is an enlarged view showing a portion around the decorative component 411 of the notebook PC shown in FIGS. 1 and 2.

The decorative component 411 is fixed to the hinge described later with a screw 42 to cover the hinge member such that the hinge member is not exposed at the external appearance.

In addition, as described later, an opening through which a cable is inserted, is arranged in a center of the decorative component 411. A cable extending between the main unit 20 and the display unit 30 is inserted through the opening so that a wiring route for the cable is regulated.

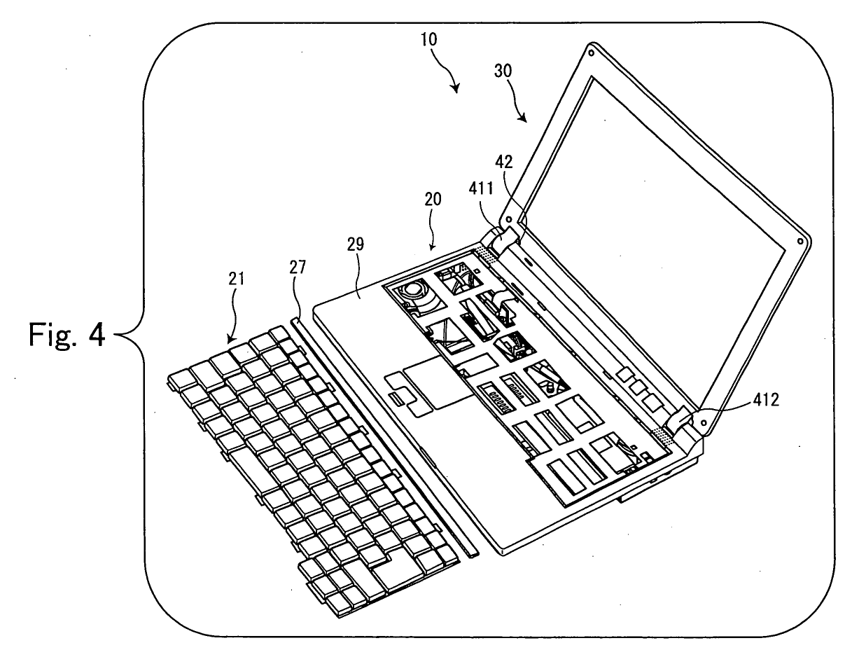

FIG. 4 is an exploded view showing the notebook PC shown in FIGS. 1 and 2 in a state in which a keyboard 21 and a decorative plate 27 are removed from the main unit 20 of the notebook PC.

In the FIG. 4, the keyboard 21 and the decorative plate 27 are removed from the main unit 20, as a result, a top cover 29 of the main unit 20 appears on a top face of the main unit 20, including a portion hindered under the keyboard 21.

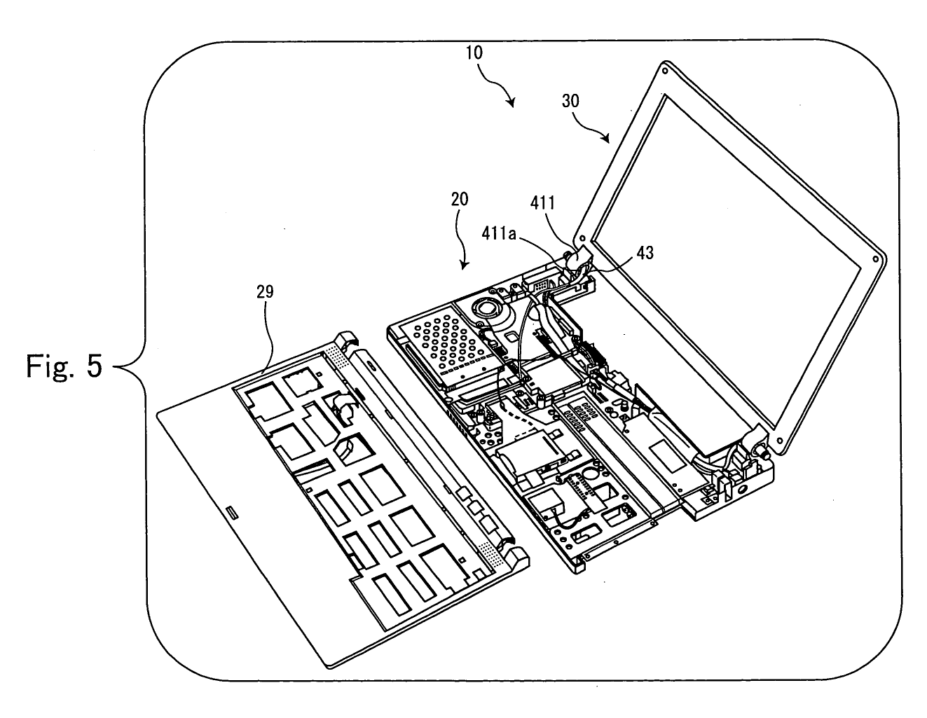

FIG. 5 is an exploded view showing the notebook PC in a state in which the top cover 29 covering a top of the main unit 20 and components fixed on the top cover are further removed from the main unit in a state in which the key board and the like are removed as shown in FIG. 4.

Since the top cover is removed, various kinds of components included in the main unit 20 are exposed. Here, explanations for the various kinds of components are omitted. A cable 43 inserted through an opening 411a arranged in the decorative component 411 for inserting a cable is shown.

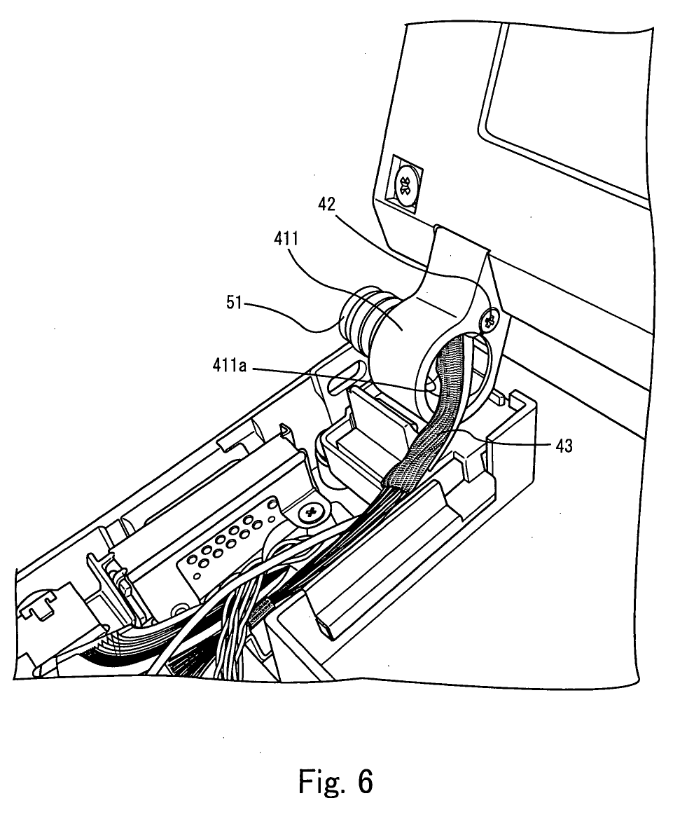

FIG. 6 is an enlarged view showing a portion around the decorative component 411 in the state shown in FIG. 5.

In FIG. 6, a state in which the cable 43 is inserted through the opening 411 arranged in the decorative component 411 for inserting a cable is clearly shown. The decorative component 411 is fixed to a hinge member 51 by the screw 42. The hinge member 51 is fixed to both the main unit 20 and the display unit 30. The hinge member 51 plays a role in supporting the main unit 20 and the display unit 30 by friction in any state in which the main unit 20 and the display unit 30 open and close with respect to each other as well as joining the main unit 20 with the display unit 30.

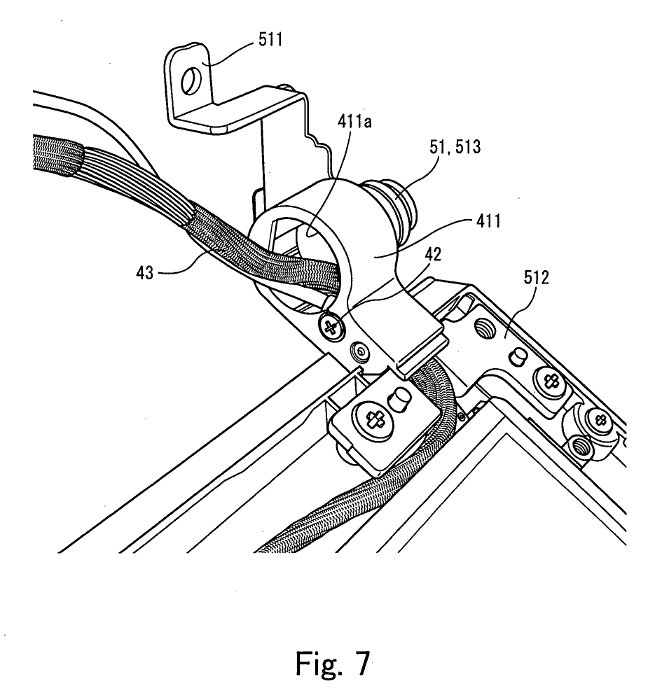

FIG. 7 is an enlarged view showing a portion around the decorative component 411 in a state in which the main unit 20 is removed from the state shown in FIGS. 5 and 6.

The hinge member 51 includes a main unit fixing section 511, a display unit fixing section 512 and a joint section 513. The main unit fixing section 511 is fixed to the main unit. The display unit fixing section 512 is fixed to he display unit. The joint section 513 joints rotationally with a predetermined friction the main unit fixing section 511 with the display unit fixing section 512. The decorative component 411 is fixed to the hinge member 51 by the screw 42 such that the decorative component 411 covers the joint section 513.

In addition, the cable 43 goes through the cable inserting opening 411a, extends between the main unit 20 and the display unit 30 to electrically connect the main unit 20 and the display unit 30.

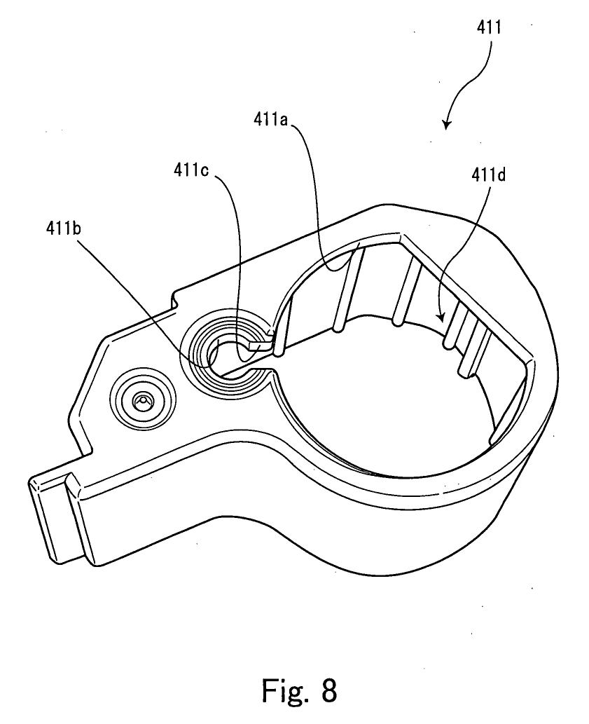

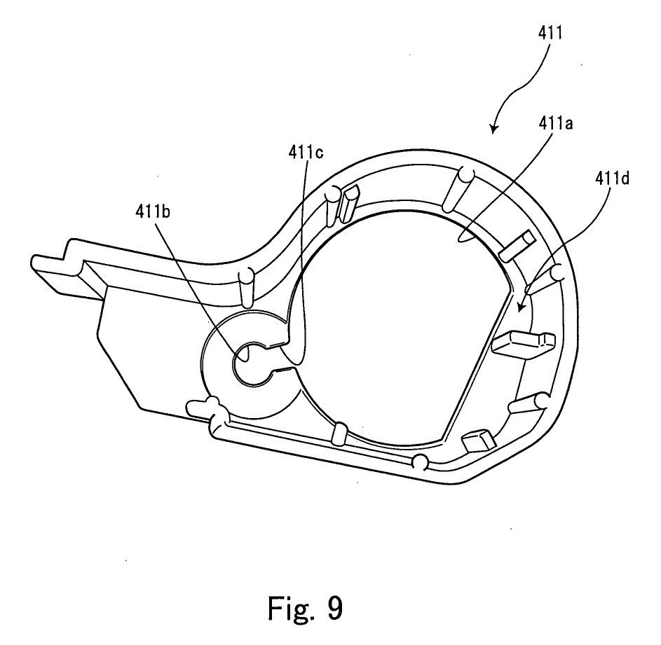

FIGS. 8 and 9 are perspective views showing the decorative component itself from the front side and from the backside respectively.

The cable inserting opening 411a and a screw fixing opening 411b are formed in the decorative component 411. The two openings 411a and 411b are mutually connected through a slit 411c. Further, a wide inner space 411d for housing a portion of the hinge member 51 is formed in the decorative component 411.

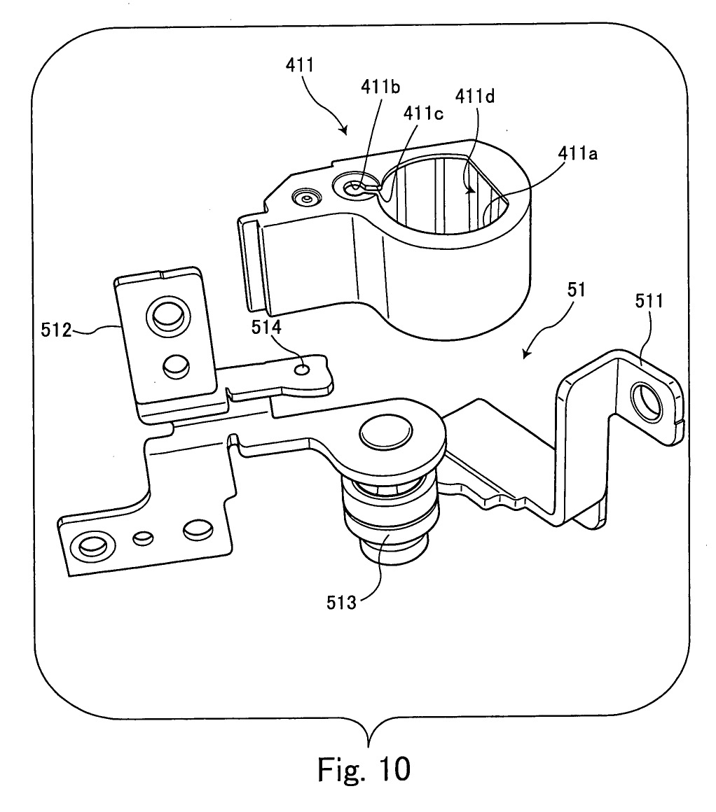

FIG. 10 is a perspective exploded view showing a positional relation between the hinge member and the decorative component.

The decorative component 411 houses a portion of a connecting section 513 of the hinge member 51 in the inner space 411d, and is disposed at a position in which the screw fixing opening 411b is disposed the screw opening 514 arranged in the hinge member 51.

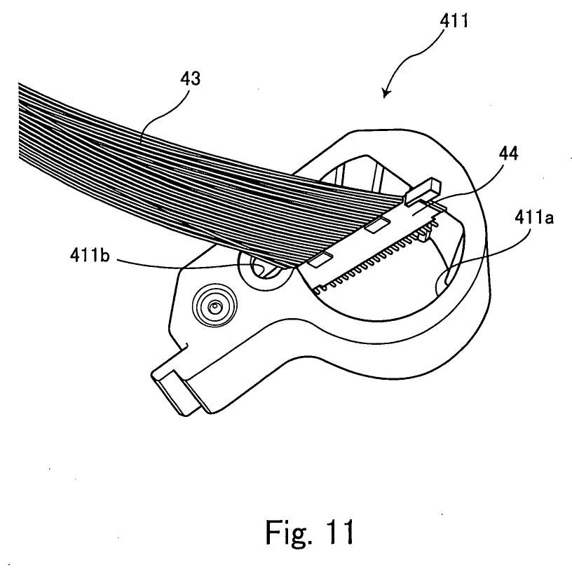

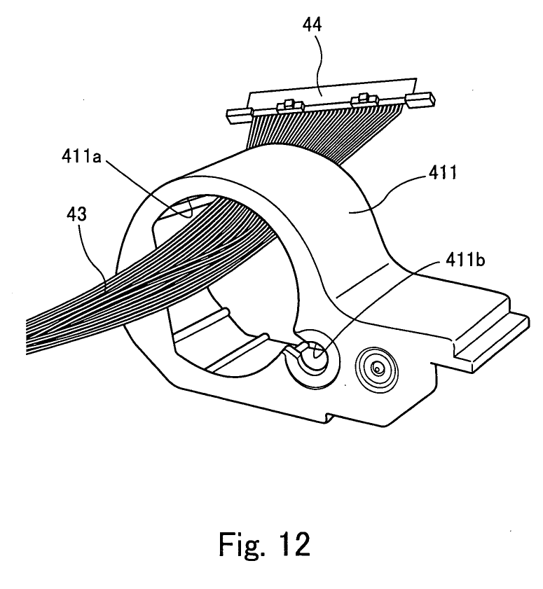

FIGS. 11 and 12 are diagrams showing a state in which a cable is inserted through the decorative component.

A connector 44 is provided at a tip of the cables 43 (hereinafter sometimes collectively referred to as “cable 43”). The connector 44 is connected to the cables 43 in an aligned state. The connector 44 is wider than a diameter of the cable inserting opening 411a and diameter of the cables 43 bound together is narrower than the diameter of the cable inserting opening 411a. Accordingly, when the connector 44 at the tip of the cable 43 is inserted through the cable inserting opening 411a of the decorative component 411, as shown in FIG. 11, the connector 44 is inserted through the cable inserting opening 411a such that a portion of the cable 43 also comes in the screw fixing opening 411b. Thus, the tip of the cable 43 can be readily inserted through the cable inserting opening 411a of the decorative component 411, thereby operability is improved.

After the tip of the cables 43 is inserted into the cable inserting opening 411a of the decorative component 411, as shown in FIG. 12, there remains a sufficient space of the cable inserting opening 411a, thereby allowing the cable 43 to be smoothly inserted through the cable inserting opening 411a.

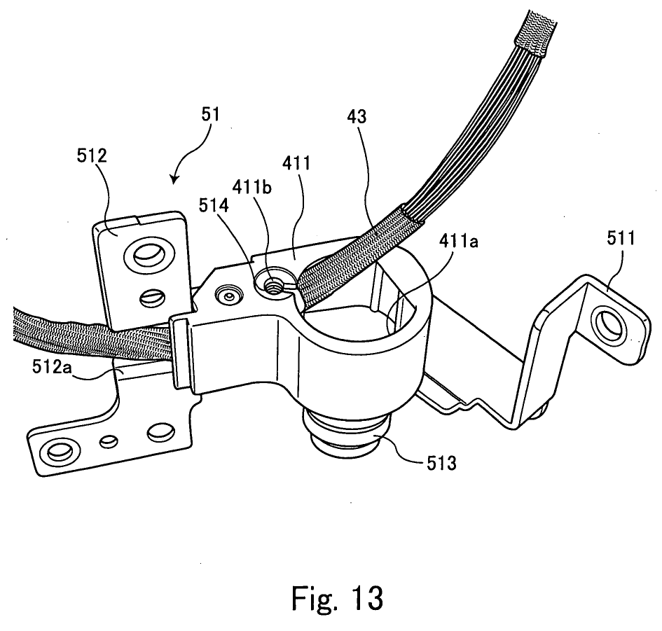

FIG. 13 is a perspective view showing the decorative component in a state in which the cable is inserted through the decorative component, and the decorative component is arranged on the hinge member.

The cable 43 goes through the cable inserting opening 411a arranged in the decorative component 411, and extends through an indent section 512a of the display unit fixing section 512 in the hinge member 51. One end of the cable 43 is connected to the inside of the main unit and the other end of the cable 43 is connected to the inside of the display unit.

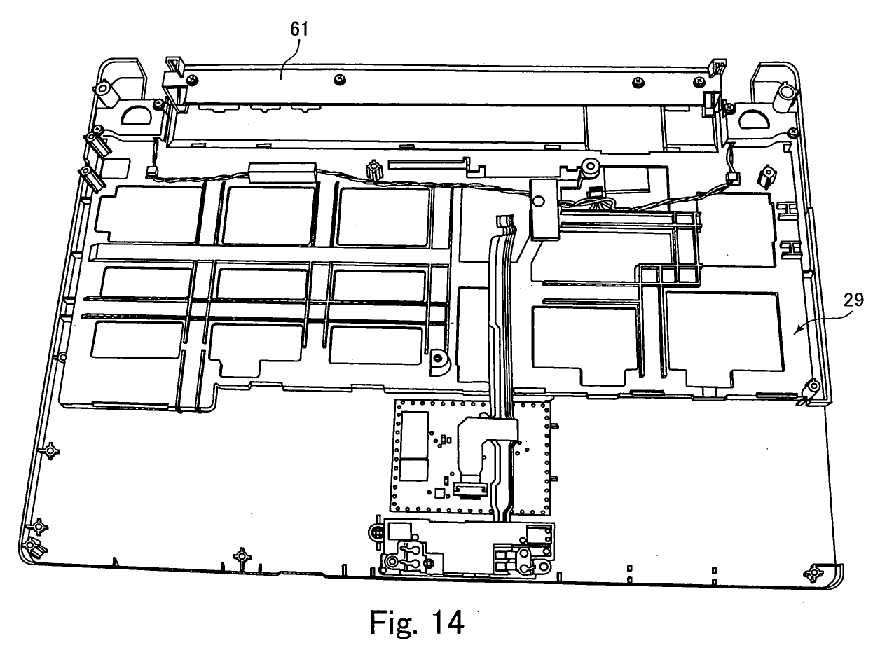

FIG. 14 is a perspective view showing an inner face of the top cover 29 covering the main unit 20, when the top cover is removed as shown in FIG. 5.

Some components are arranged on the inner face of the top cover 29. Here, of those components, a board fixing member 61 to which a flexible board described later is fixed will be described.

The board fixing member 61 is fixed inside the top cover 29, specifically at rear side of the top cover 29, where the main unit 20 (for example, see FIG. 5) is hinged to the display unit 30.

FIG. 14 illustrates a back of the board fixing member 61 with respect to a supporting face for supporting the flexible board.

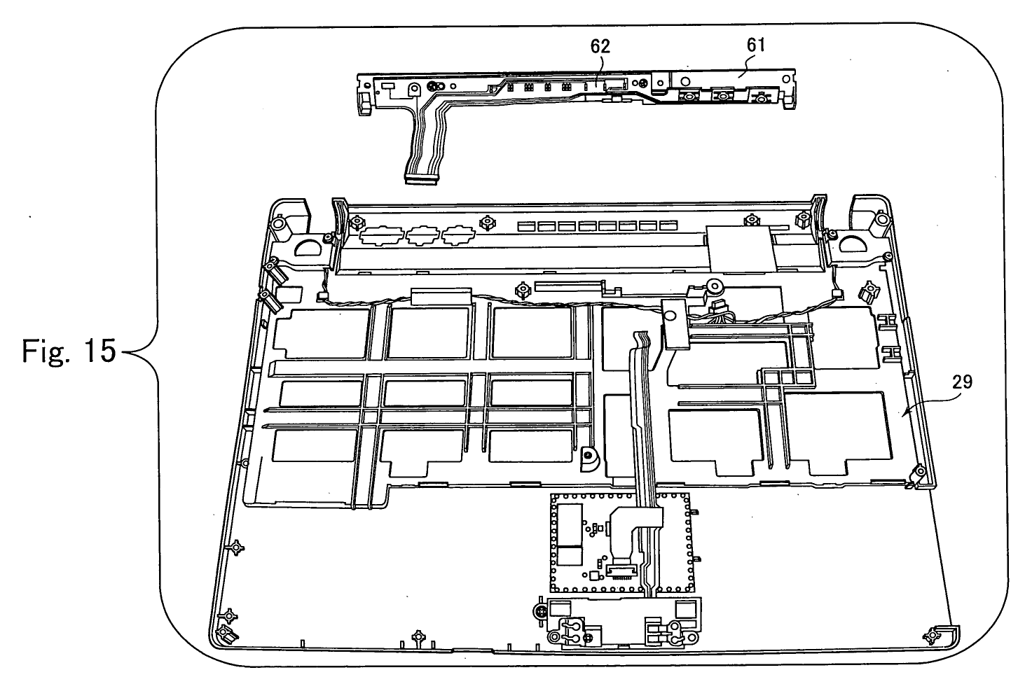

FIG. 15 is a perspective exploded view showing the inner face of the top cover 29 and the board fixing member 61 in the state in which it is removed from the top cover. FIG. 15 illustrates the board fixing member 61 in a state in which a face supporting the flexible board 62 faces upward.

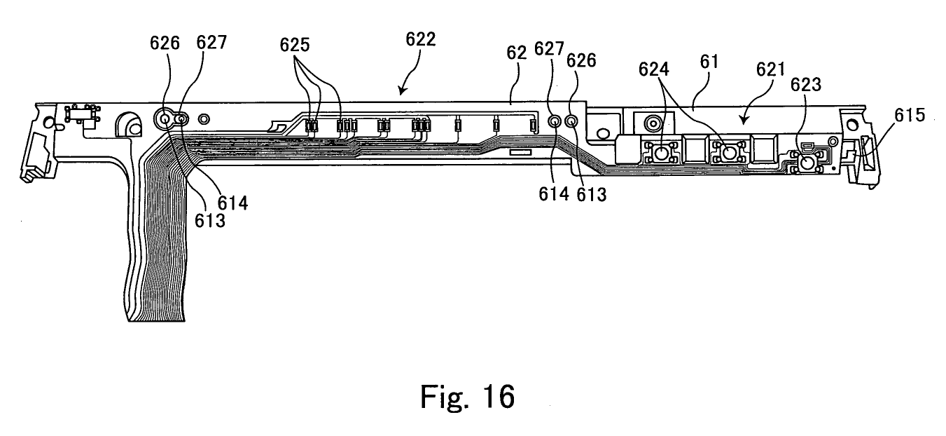

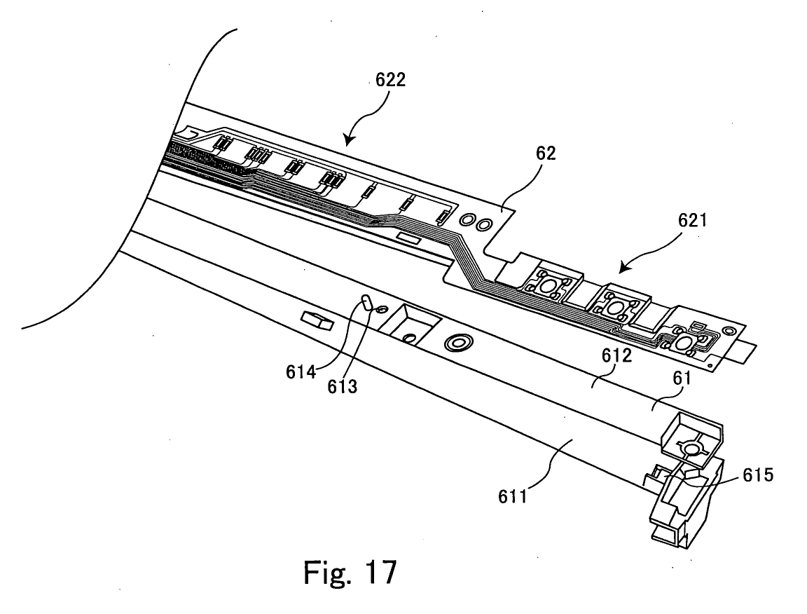

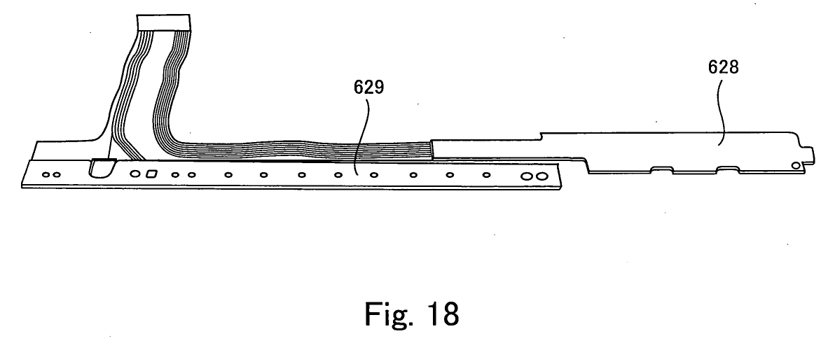

FIG. 16 is an enlarged perspective view showing the board fixing member 61 in a state in which the flexible board 62 is fixed to the board fixing member 61. FIG. 17 is an exploded perspective view showing both the flexible board 62 and the board fixing member 61. FIG. 18 is a perspective view showing a back face of the flexible board 62.

As shown in FIG. 17, the circuit board fixing member 61 includes a first circuit board supporting face 611 and a second circuit board supporting face 612. The first circuit board supporting face 611 faces obliquely upward and the second circuit board supporting face faces upward. Oh the other hand, the flexible circuit board 62 includes a first supported portion 621 and a second supported portion 622 which are supported by the first and second circuit board supporting faces 611 and 612 of the circuit board fixing member 61 respectively.

As shown in FIG. 16, a push button switch 623 and two function switches 624 are arranged in the first portion 621 of the flexible board 62. Plural light emitting devices 625 are arranged in the second portion 622 of the flexible board 62. In addition, a screw fixing opening 626 is arranged in the second portion 622, and a positioning opening 627 is also arranged in the second portion 622.

On the other hand, in the second board supporting face 612 of the board fixing member 61, a tapped hole 613 is formed at a position corresponding to the screw fixing opening 626 disposed in the flexible board 62, and a positioning boss 614 stands at a position corresponding to the positioning opening 627 disposed in the flexible board 62 (see FIG. 17).

In addition, an engaging section 615 which engages a tip of the first portion 621 of the flexible board 62 is disposed in the board fixing section 61.

In addition, as shown in FIG. 18, in a bottom face of the flexible board 61, a first reinforcement plate 628 is attached to the back of the first portion 621 of the flexible board 62, and a second reinforcement member 629 is attached to the back of the second portion 622 of the flexible board 62.

The first and second reinforcement plates 628 and 629 are components independent to each other. A part of the flexible board 62 corresponding to a gap between the first and second reinforcement plates 628 ad 629 has flexibility. Because this flexible part can bend, the first portion 621 is stably supported by the first board supporting face 611 of the board fixing member 61 and the second portion 622 is stably supported by the second board supporting face 612 of the board fixing member 61.

When the flexible board 62 is fixed on the board fixing member 61, the second portion 622 of the flexible board 62 is placed on the second board supporting face 612 of the board fixing member 61 such that a tip of the first portion 621 of the flexible board 62 (a tip of the first reinforcement plate 628) is engaged with the engaging section 615 disposed in the first board supporting face 611 of the board fixing member 61, and the positioning boss 614 disposed in the second board supporting face 612 of the board fixing member 61 is engaged into the positioning opening 627 disposed in the second portion 622 of the flexible board 62. Accordingly, since the screw fixing opening 626 disposed in the second portion 622 of the flexible board 62 is overlapped with the tapped hole 613 disposed in the second supporting face of the board fixing member 61, the flexible board 62 is fixed by a screw to the board fixing member 61, using the screw fixing opening 626 and the tapped hole 613. Thus, by the structure in which the first portion 621 of the flexible board 62 is only engaged and the second portion 622 is fixed by a screw, assembling is readily performed. Further, providing the positioning opening 627 and the positioning boss 614 improves workability. However, positioning the screw fixing opening 626 to the tapped hole 613 is not much difficult. Therefore, the positioning opening 627 and the positioning boss 614 are not necessarily required.

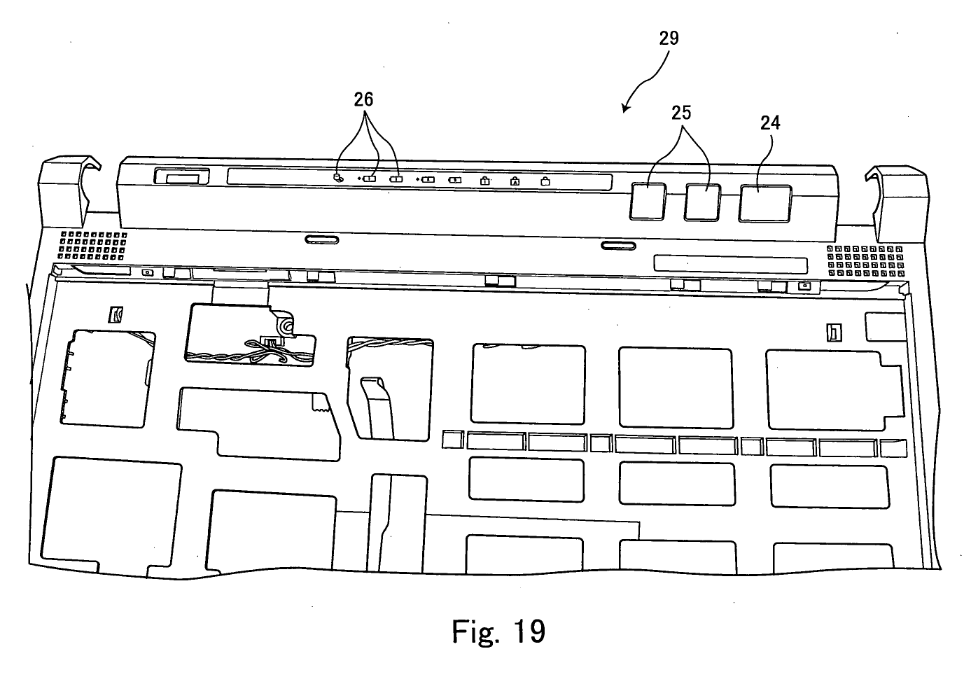

FIG. 19 is an enlarged view showing a front face of a portion of the top cover covering a top of the main unit 20 to which portion the board fixing member 61 is fixed.

In the top cover 29, the power button 24 for pushing the push button switch 623 in response to pushing down is arranged at a position corresponding to the push button switch 623 for switching the power on and off disposed on the flexible board 62 (see FIG. 16) fixed to the board fixing member 61 (see FIG. 14) fixed on the back face of the top cover 29. The two function buttons 25 for pushing down the corresponding function switches 624 in response to pushing down are arranged at positions corresponding to the two function switches 624 on the flexible board 62 respectively.

Since the power button 24 and function button 25 are pushed obliquely downward, the push button switch 623 and function switch 624 both on the flexible board 62 are mounted on the first portion 621 of the flexible board 62. The first portion 621 is supported by the first board supporting face 611 of the board fixing member 61. The first board supporting face faces obliquely downward.

In addition, the top cover 29 is formed by using white a color plastic which allows light to scatter and transmit. The various display marks 26 recalling the meaning of light emitting of the light emitting devices 625 are formed at a portion of the top cover 29, which portion is right above the light emitting devices 625 (see FIG. 16) arranged on the flexible board 62, and which portion covers the second portion 622 of the flexible board 62. The light emitting devices 625 on the flexible board 62 is arranged on the second portion 622 of the flexible board 62, which portion 622 is supported by the second board supporting face 612 of the board fixing member 61. Corresponding to this arrangement, the various kinds of display marks 26 formed on the top cover 29 are formed in a portion of the top cover 29 which portion faces upward.

What is claimed is:

1. An electronic apparatus comprising:
a component including a first opening through which a cable is inserted,
wherein the cable includes a connector section having a width larger than a diameter of the first opening and a cable section having a width which enables the cable to be inserted through the first opening, and
the cable further includes a second opening which is connected to the first opening such that the connector section of the cable can be accepted when the cable is inserted through the first opening.

2. An electronic apparatus comprising:
a component in which a first opening and a second opening are arranged, the first opening through which a cable is inserted, the second opening through which a fastening component is inserted, wherein the second opening is connected to the first opening such that the second opening accepts a portion of the cable when the cable is inserted through the first opening.

3. The electronic apparatus according to claim 1, further comprising:
a first unit and a second unit both of which open and close with respect to each other; and
a hinge member that connects the first and second units such that the first and second units freely open and close with respect to each other and that supports the first and second units in any state in which the first and second units open and close,
wherein the component is a component through which a cable extending between the first and second units is inserted and which is fixed to the hinge member.

4. The electronic apparatus according to claim 2 comprising:
a first unit and a second unit both of which open and close with respect to each other; and
a hinge member that connects the first and second units such that the first and second units freely open and close with respect to each other and that supports the first and second units in any state in which the first and second units open and close,
wherein the component is a component through which a cable extending between the first and second units is inserted and which is fixed to the hinge member.

5. The electronic apparatus according to claim 3, wherein the component is a component which is fixed to the hinge member by a screw which is inserted through the second opening.

6. The electronic apparatus according to claim 4, wherein the component is a component which is fixed to the hinge member by a screw which is inserted through the second opening.

7. The electronic apparatus according to claim 5, wherein the component is a component which regulates a route of wiring a cable by inserting the cable through the first opening, and which is fixed to the hinge member to cover an external appearance of the hinge member.

8. A component that is used for an electronic apparatus and that includes a first opening through which a cable is inserted, wherein:
the cable includes a connector section having a width larger than a diameter of the first opening and a cable section having a width which enables the cable to be inserted through the first opening, and
the component includes a second opening which is connected to the first opening such that the connector section of the cable can be accepted when the cable is inserted through the first opening.

9. A component used for an electronic apparatus wherein:
a first opening through which a cable is inserted and a second opening through which a fastening component is inserted are formed thereon, and
the second opening is connected to the first opening such that the second opening accepts a portion of the cable when the cable is inserted through the first opening.

10. The component according to claim 8, wherein the electronic apparatus includes a first unit and a second unit both of which open and close with respect to each other, and a hinge member that connects the first and second units such that the first and second units freely open and close to each other and that supports the first and second units in any state in which the first and second units open and close, and
the component is a component through which a cable extending between the first and second units is inserted and which is fixed to the hinge member.

11. The component according to claim 9, wherein the electronic apparatus includes a first unit and a second unit both of which open and close with respect to each other, and a hinge member that connects the first and second units such that the first and second units freely open and close with respect to each other and that supports the first and second units in any state in which the first and second units open and close, and
the component is a component through which a cable extending between the first and second units is inserted and which is fixed to the hinge member.

12. The component according to claim 10, wherein the component is fixed to the hinge member by a screw which is inserted through the second opening.

13. The component according to claim 11, wherein the component is fixed to the hinge member by a screw which is inserted through the second opening.

14. The component according to claim 10, wherein the component regulates a route of wiring a cable by inserting the cable through the first opening, and which is fixed to the hinge member to cover an external appearance of the hinge member.

15. The component according to claim 11, wherein the component regulates a route of wiring a cable by inserting the cable through the first opening, and which is fixed to the hinge member to cover an external appearance of the hinge member.
